(19) United States
(12) Patent Application Publication
(10) Pub. No.: US 2019/0179821 A1
(43) Pub. Date: Jun. 13, 2019

(54) METHOD AND SYSTEM FOR ACCESSING OUT-OF-CHAIN DATA BASED ON CONSORTIUM BLOCK CHAIN

(71) Applicant: ZhongAn Information Technology Service Co., Ltd., Shenzhen (CN)

(72) Inventor: Beishuang FAN, Shenzhen (CN)

(21) Appl. No.: 16/282,051

(22) Filed: Feb. 21, 2019

Related U.S. Application Data
(63) Continuation of application No. PCT/CN2018/095823, filed on Jul. 16, 2018.

(30) Foreign Application Priority Data
Aug. 1, 2017 (CN) 201710648388.X

(51) Int. Cl. G06F 16/2455; G06F 21/60; G06F 16/27; G06Q 50/18

(52) U.S. Cl. CPC G06F 16/24553; G06Q 50/18; G06F 16/27; G06F 21/604

(57) ABSTRACT

The present disclosure discloses a method and a system for accessing out-of-chain data based on a consortium block chain. The method for accessing out-of-chain data is performed by an agent program, and the method for accessing out-of-chain data includes: obtaining an access request to out-of-chain data sources sent by a first smart contract on the consortium block chain from a second smart contract, wherein the second smart contract is generated based on the out-of-chain data sources and is deployed on the consortium block chain; searching out-of-chain data in the out-of-chain data sources according to the access request; and sending the out-of-chain data to the second smart contract.

### CROSS-REFERENCE TO RELATED APPLICATIONS

The present disclosure is a continuation of international application No. PCT/CN2018/095823 filed on Jul. 16, 2018, which claims priority to Chinese patent application No. 201710648388.X, entitled “Method and System for Accessing Out-of-chain Data Based on Consortium Block Chain” and filed on Aug. 1, 2017 by the present applicant, all contents of which are incorporated herein in its entirety by reference.

### TECHNICAL FIELD

The present disclosure relates to block chain technologies, and more particularly, to a method and a system for accessing out-of-chain data based on a consortium block chain.

### BACKGROUND

Block chain (Block Chain) technologies are a decentralized peer-to-peer network, and combines cryptography principles with consensus mechanisms to ensure the consistency and continuity of data of distributed nodes and realize instant verification, traceability, difficulty in tampering and unblocking of information, and thus a set of private, efficient and secure shared value systems is created.

Block chains are usually divided into public block chains, consortium block chains and private block chains according to access permissions. The public block chains refer to block chains that anyone can access and participate in consensus according to agreements; the consortium block chains refer to block chains of which a consensus process is controlled by pre-selected nodes; the private block chains refer to block chains that all permissions are in one organization and are arbitrarily controlled by the organization.

Smart contracts are decentralized application technologies for realizing complex functions provided by the block chain technologies. The smart contracts are written in a high-level language, and are compiled by corresponding compilers to generate codes that are recognized and executed by the block chains and are deployed in the block chains to provide corresponding functions.

In prior block chain technologies, an operating environment of smart contracts is strictly isolated, that is, the smart contracts cannot interact with out-of-chain data. However, in actual situation, an actual value of a smart contract that does not access the out-of-chain data is very limited. With the field of block chain applications continues to expand, the need for the smart contracts to access the out-of-chain data is growing. However, under the prior technical conditions, there is no unified standard way to realize the access of the smart contracts to a variety of out-of-chain data. Therefore, the problem that the smart contracts access out-of-chain data has become a key problem that restricts the widespread use of the smart contracts.

### SUMMARY

In view of this, embodiments of the present disclosure provide a method and a system for accessing out-of-chain data based on a consortium block chain, which may realize the access of the smart contracts to a variety of out-of-chain data sources in a unified standard manner on the consortium block chain while ensuring the security of the access.

According to a first aspect of an embodiment of the present disclosure, there is provided a method for accessing out-of-chain data based on a consortium block chain, wherein the method for accessing out-of-chain data is performed by an agent program, the method for accessing out-of-chain data including: obtaining an access request to out-of-chain data sources sent by a first smart contract on the consortium block chain from a second smart contract, wherein the second smart contract is generated based on the out-of-chain data sources and is deployed on the consortium block chain; searching out-of-chain data in the out-of-chain data sources according to the access request; and sending the out-of-chain data to the second smart contract.

According to a second aspect of an embodiment of the present disclosure, there is provided a method for accessing out-of-chain data based on a consortium block chain, wherein the method for accessing out-of-chain data is performed by a second smart contract, and the second smart contract is generated based on out-of-chain data sources and is deployed on the consortium block chain. The method for accessing out-of-chain data includes: receiving an access request to the out-of-chain data sources sent by a first smart contract on the consortium block chain; receiving a query request sent by an agent program, wherein the query request is used to request a query whether the access request exists; receiving out-of-chain data in the out-of-chain data sources returned by the agent program; and sending the out-of-chain data to the first smart contract.

According to a third aspect of an embodiment of the present disclosure, there is provided a system for accessing out-of-chain data based on a consortium block chain, wherein the system for accessing out-of-chain data runs an agent program to realize an access of the out-of-chain data, the system for accessing out-of-chain data including: a processor; and a memory for storing instructions executable by the processor; wherein the processor is configured to: obtain an access request to out-of-chain data sources sent by a first smart contract on the consortium block chain from a second smart contract, wherein the second smart contract is generated based on the out-of-chain data sources and is deployed on the consortium block chain; search out-of-chain data in the out-of-chain data sources according to the access request; and send the out-of-chain data to the second smart contract.

According to a forth aspect of an embodiment of the present disclosure, there is provided a system for accessing out-of-chain data based on a consortium block chain, wherein the system for accessing out-of-chain data runs a second smart contract to realize an access of the out-of-chain data, and the second smart contract is generated based on out-of-chain data sources and is deployed on the consortium block chain, the system for accessing out-of-chain data including: a processor; and a memory for storing instructions executable by the processor; wherein the processor is configured to: receive an access request to the out-of-chain data sources sent by a first smart contract on the consortium block chain receive a query request sent by an agent program, wherein the query request is used to request a query whether the access request exists, and receive out-of-chain data in the out-of-chain data sources returned by the agent program; and send the out-of-chain data to the first smart contract.

According to a fifth aspect of an embodiment of the present disclosure, there is provided a computer readable storage medium storing computer executable instructions, wherein when executed by a processor of a system, the executable instructions cause the system to perform a method for accessing out-of-chain data, the method including: obtaining an access request to out-of-chain data sources sent by a first smart contract on a consortium block chain from a second smart contract, searching out-of-chain data in the out-of-chain data sources according to the access request, and sending the out-of-chain data to the second smart contract, wherein the second smart contract is generated based on the out-of-chain data sources and is deployed on the consortium block chain.

According to a sixth aspect of an embodiment of the present disclosure, there is provided a computer readable storage medium storing computer-executable instructions that, when executed by a processor of a system, cause the system to perform a method for accessing out-of-chain data, the method including: receiving an access request to the out-of-chain data sources sent by a first smart contract on a consortium block chain; receiving a query request sent by an agent program, wherein the query request is used to request a query whether the access request exists; receiving out-of-chain data in the out-of-chain data sources returned by the agent program; and sending the out-of-chain data to the first smart contract.

### BRIEF DESCRIPTION OF THE DRAWINGS

FIG. 1 is a flowchart of a method for accessing out-of-chain data based on a consortium block chain according to an exemplary embodiment of the present disclosure;

FIG. 2 is a flowchart of a method for accessing out-of-chain data based on a consortium block chain according to another exemplary embodiment of the present disclosure;

FIG. 3 is a flowchart of a method for accessing out-of-chain data based on a consortium block chain according to another exemplary embodiment of the present disclosure;

FIG. 4 is a block diagram of a system for accessing out-of-chain data based on a consortium block chain according to an exemplary embodiment of the present disclosure;

FIG. 5 is a block diagram of a system for accessing out-of-chain data based on a consortium block chain according to another exemplary embodiment of the present disclosure; and

FIG. 6 is a block diagram of a system for accessing out-of-chain data based on a consortium block chain according to an exemplary embodiment of the present disclosure.

### DETAILED DESCRIPTION

FIG. 1 is a flowchart of a method for accessing out-of-chain data based on a consortium block chain according to an exemplary embodiment of the present disclosure. The method for accessing out-of-chain data of FIG. 1 is performed by an agent program. As shown in FIG. 1, the method for accessing out-of-chain data includes 110-130.

110: An access request to out-of-chain data sources sent by a first smart contract on the consortium block chain is obtained from a second smart contract, wherein the second smart contract is generated based on the out-of-chain data sources and is deployed on the consortium block chain.

In an embodiment of the present disclosure, the agent program obtains the access request to the out-of-chain data sources sent by the first smart contract on the consortium block chain from the second smart contract, wherein the second smart contract is generated based on the out-of-chain data sources and is deployed on the consortium block chain; that is, the first smart contract registers query data to the second smart contract, and the second smart contract interacts with the agent program as an intermediate contract to access the out-of-chain data sources.

Specifically, the agent program and the second smart contract are pre-built to serve as an infrastructure of the subsequence accesses. The agent program is usually developed by programmers for certain kinds of out-of-chain data sources, and because the reason is that managers and management manners of various kinds of out-of-chain data sources are different, for example, queries including passenger information, flight information and the like may be supported by aviation data sources. It should be noted that how to develop an agent program is a prior mature technology in the art, and thus it will not be repeated herein. Further, an administrator of the consortium block chain may obtain the agent program, assign an address to the agent program and store an address of the second smart contract in the agent program. Since above operations are performed by the administrator, the identity of the agent program that uploads data may be restricted. An address of the agent program may be used for transactions between the agent program and the second smart contract. In addition, the agent program may run on a server with the consortium block chain, or may also run on a server without the consortium block chain, and the present disclosure is not limited thereto.

The first smart contract may be a smart contract deployed on the consortium block chain, and the second smart contract may be a data source smart contract. For different out-of-chain data sources, corresponding second smart contracts may be generated, and accesses to corresponding variety of out-of-chain data sources are realized by different second smart contracts. The second smart contract is pre-deployed on the consortium block chain as an intermediate contract for exchange of data with outside world, and the address of the second smart contract is published to the smart contract deployed on the consortium block chain, and the second smart contract includes a query method, so it is convenient for the smart contract on the consortium block chain such as a customer contract to invoke when accessing the out-of-chain data sources. It should be noted that the first smart contract may be one or more, and the second smart contract may be one or more.

The out-of-chain data sources may include but are not limited to meteorological or weather data sources, stock market transaction data sources, foreign exchange data sources, traffic data sources and the like. In addition, the out-of-chain data source may be one or may be more, and the present disclosure is not limited thereto. Embodiments of the present disclosure may simultaneously support multiple out-of-chain data sources, different out-of-chain data sources have different query parameters and response data formats, and may widely access various out-of-chain data sources such as weather, aviation, stock market, foreign exchange and the like. Therefore, there is greater flexibility.

120: Out-of-chain data in the out-of-chain data sources are searched according to the access request.

In an embodiment of the present disclosure, after obtaining the access request, the agent program queries out-of-chain data corresponding to the access request in the out-of-chain data sources according to the access request. Here, the out-of-chain data may include one or more of meteorological data or weather data, stock market transaction data, foreign exchange data and traffic data.

130: The out-of-chain data is sent to the second smart contract.

In an embodiment of the present disclosure, the agent program sends the discovered out-of-chain data to the second smart contract.

According to technical solutions provided by the embodiments of the present disclosure, by obtaining an access request to out-of-chain data sources sent by a first smart contract on a consortium block chain from a second smart contract, wherein the second smart contract is generated based on the out-of-chain data sources and is deployed on the consortium block chain; searching out-of-chain data in the out-of-chain data sources according to the access request; and sending the out-of-chain data to the second smart contract, the access of the smart contracts to a variety of out-of-chain data sources may be realized in a unified standard manner on the consortium block chain while ensuring the security of the access.

In another embodiment of the present disclosure, the obtaining an access request to out-of-chain data sources sent by a first smart contract on the consortium block chain from a second smart contract includes: querying the second smart contract actively to obtain the access request to the out-of-chain data sources sent by the first smart contract on the consortium block chain.

Specifically, the agent program actively queries the second smart contract at a pre-set time interval (for example, 5 seconds) to obtain the access request to the out-of-chain data sources sent by the first smart contract on the consortium block chain. Here, the pre-set time interval may be a time interval that a server defaults, or may be a time interval set by an administrator according to actual needs, and the present disclosure is not limited thereto.

It should be noted that an address of the agent program is assigned by the administrator, so that only the agent program for credit granting is allowed to response to the query request, and any other organization or individual cannot response, therefore, the security of accessing the out-of-chain data is greatly enhanced.

In another embodiment of the present disclosure, the searching out-of-chain data in the out-of-chain data sources according to the access request includes: sending a query request to the out-of-chain data sources according to the access request; and receiving out-of-chain data returned by the out-of-chain data sources.

Specifically, after obtaining the access request, the agent program sends the query request to the out-of-chain data sources; further, after receiving the query request, the out-of-chain data sources query the out-of-chain data stored therein, and sends a query result to the agent program, and the agent program receives a response of the out-of-chain data sources.

The embodiment of the present disclosure has a function of managing and constraining the agent program of the out-of-chain data sources, since only the agent program for credit granting is allowed to response to the query request, and any other organization or individual cannot response, therefore, the security of the out-of-chain data access is greatly enhanced, so as to make the introduction of the out-of-chain data sources in the already running block chain more secure in a controlled manner.

In another embodiment of the present disclosure, the sending the out-of-chain data to the second smart contract includes: initiating a transaction to the second smart contract according to an address of the second smart contract, and sending the out-of-chain data.

Specifically, the agent program initiates a transaction to the second smart contract according to the address of the second smart contract, and transmits a query result of the out-of-chain data to the second smart contract.

In another embodiment of the present disclosure, the agent program stores an address of the second smart contract.

Specifically, the administrator stores the address of the second smart contract in the agent program, so that the agent program obtains actively query parameters from the second smart contract, and returns the query result.

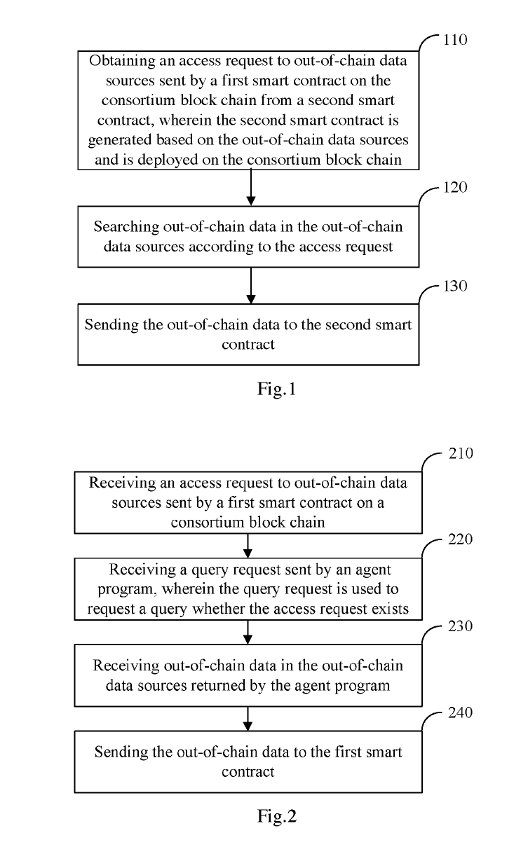

FIG. 2 is a flowchart of a method for accessing out-of-chain data based on a consortium block chain according to another exemplary embodiment of the present disclosure. The method for accessing out-of-chain of FIG. 2 may be performed by a second smart contract. As shown in FIG. 2, the method for accessing out-of-chain includes 210-240.

210: An access request to out-of-chain data sources sent by a first smart contract on the consortium block chain is received.

In an embodiment of the present disclosure, the first smart contract deployed on the consortium block chain sends the access request for the out-of-chain data sources to the second smart contract. Here, the out-of-chain data sources may include but are not limited to meteorological or weather data sources, stock market transaction data sources, foreign exchange data sources, traffic data sources and the like. In addition, the out-of-chain data sources may be one or more, and the present disclosure is not limited thereto.

220: A query request sent by an agent program is received, and the query request is used to request a query whether the access request exists.

In an embodiment of the present disclosure, the agent program sends the query request to the second smart contract at a pre-set time interval, and the query request is used to request the query whether the access request to the out-of-chain data sources exists. Here, the agent program may run on a server with the consortium block chain, or run on a server without the consortium block chain, the present disclosure is not limited thereto.

230: Out-of-chain data in the out-of-chain data sources returned by the agent program is received.

In an embodiment of the present disclosure, the agent program sends the out-of-chain data in the out-of-chain data sources corresponding to the access request to the second smart contract.

240: The out-of-chain data is sent to the first smart contract.

In an embodiment of the present disclosure, after receiving the out-of-chain data sent by the agent program, the second smart contract sends the out-of-chain data to the first smart contract.

According to technical solutions provided by the embodiments of the present disclosure, by receiving an access request to out-of-chain data sources sent by a first smart contract on a consortium block chain; receiving a query request sent by an agent program, wherein the query request is used to request a query whether the access request exists; receiving out-of-chain data in the out-of-chain data sources returned by the agent program; and sending the out-of-chain data to the first smart contract, an access function of the out-of-chain data may be quickly introduced on a prior block chain platform without modifying an underlying engine of the smart contract to realize the access to a plurality of out-of-chain data sources, and thus the implementation is simplified and the implementation cycle is shortened.

In another embodiment of the present disclosure, an address of the second smart contract is published on the consortium block chain, and the access request includes a query request, and after the receiving an access request to the out-of-chain data sources sent by a first smart contract on the consortium block chain, the method for accessing out-of-chain data further includes: storing the query request and an address of the first smart contract, wherein the receiving an access request to the out-of-chain data sources sent by a first smart contract on the consortium block chain includes: receiving the query request sent by invoking an address of the second smart contract and a query method of the second smart contract when the first smart contract needs to access to the out-of-chain data sources, wherein the sending the out-of-chain data to the first smart contract includes: sending a notification to the first smart contract according to the address of the first smart contract, and sending the out-of-chain data.

Specifically, the address of the second smart contract is published on the consortium block chain, and after receiving the access request to the out-of-chain data source sent by the first smart contract on the consortium block chain, the second smart contract saves the query request and the address of the first smart contract that initiates the query request. That is, the second smart contract saves the out-of-chain data query request for the agent program to query and receive, and the second smart contract also saves the address of the first smart contract that initiates the out-of-chain data query request for the second smart contract to send the notification to the smart contract that initiates the out-of-chain data query request, and transmit an out-of-chain data query result to the first smart contract.

Further, when accessing the out-of-chain data sources is required, the first smart contract (for example, customer contract) on the consortium block chain may invoke the address of the second smart contract and the query method of the second smart contract to submit the out-of-chain data query request to the second smart contract. Here, the corresponding data source smart contract and query method may be selected for different out-of-chain data sources and query demands, for example, query requests such as passenger information and flight information and the like may be selected for aviation data sources. After receiving the out-of-chain data sent by the agent program, the second smart contract sends the notification to the first smart contract according to the saved address of the first smart contract, and sends the out-of-chain data to the first smart contract, that is, when receiving the out-of-chain data query request, the second smart contract notifies the first smart contract that initiates the out-of-chain data query request and transmits the out-of-chain data query result to the first smart contract.

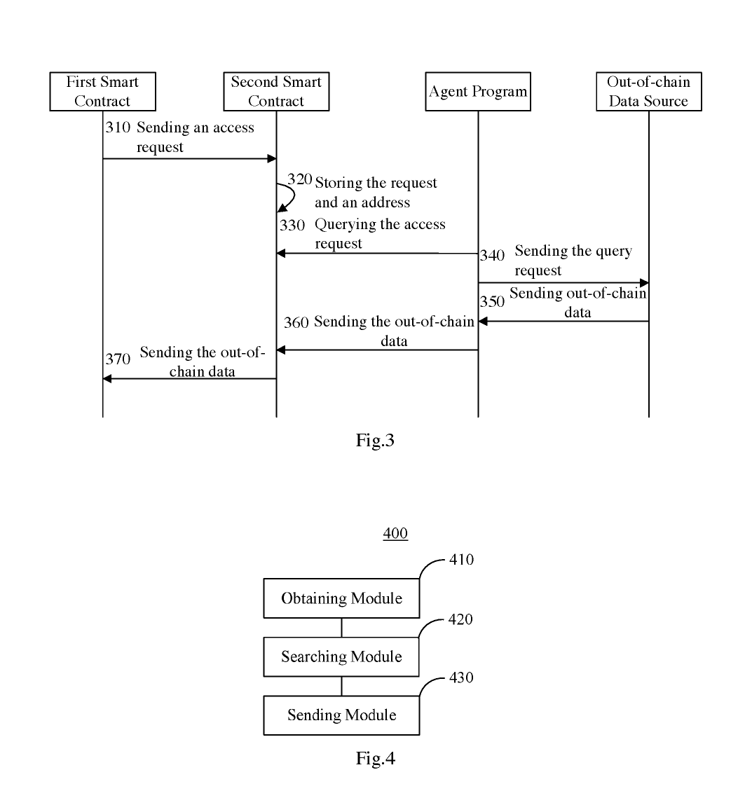

FIG. 3 is a flowchart of a method for accessing out-of-chain data based on a consortium block chain according to another exemplary embodiment of the present disclosure. The interaction entities involved in FIG. 3 are a first smart contract, a second smart contract, an agent program and out-of-chain data sources. As shown in FIG. 3, the method for accessing out-of-chain data includes 310-370.

310: A first smart contract sends an access request to out-of-chain data sources to a second smart contract.

320: The second smart contract stores the access request and an address of the first smart contract.

330: An agent program actively queries whether the access request exists.

340: The agent program sends a query request to the out-of-chain data sources.

350: The out-of-chain data sources send out-of-chain data to the agent program.

360: The agent program sends the out-of-chain data to the second smart contract.

370: The second smart contract sends the out-of-chain data to the first smart contract.

According to technical solutions provided by the embodiments of the present disclosure, the access of the smart contracts to a variety of out-of-chain data sources may be realized in a unified standard manner on the consortium block chain while ensuring the security of the access.

All of the above optional technical solutions can be combined in any way to form optional embodiments of the present disclosure, and detailed descriptions are not provided herein.

The following is an apparatus embodiment of the present disclosure, which may be configured to execute a method embodiment of the present disclosure. For details not disclosed in the apparatus embodiment of the present disclosure, please refer to the method embodiment of the present disclosure.

FIG. 4 is a block diagram of a system 400 for accessing out-of-chain data based on a consortium block chain according to an exemplary embodiment of the present disclosure. The system 400 for accessing out-of-chain data in FIG. 4 runs an agent program to realize the access of the out-of-chain data. As shown in FIG. 4, the system 400 for accessing out-of-chain data includes an obtaining module 410, a searching module 420 and a sending module 430.

The obtaining module 410 is configured to obtain an access request to out-of-chain data sources sent by a first smart contract on the consortium block chain from a second smart contract, wherein the second smart contract is generated based on the out-of-chain data sources and is deployed on the consortium block chain.

The searching module 420 is configured to search out-of-chain data in the out-of-chain data sources according to the access request.

The sending module 430 is configured to send the out-of-chain data to the second smart contract.

According to technical solutions provided by the embodiments of the present disclosure, by obtaining an access request to out-of-chain data sources sent by a first smart contract on a consortium block chain from a second smart contract, wherein the second smart contract is generated based on the out-of-chain data sources and is deployed on the consortium block chain; searching out-of-chain data in the out-of-chain data sources according to the access request; and sending the out-of-chain data to the second smart contract, the access of the smart contracts to a variety of out-of-chain data sources may be realized in a unified standard manner on the consortium block chain while ensuring the security of the access.

In another embodiment of the present disclosure, the obtaining module 410 in FIG. 4 queries the second smart contract actively to obtain the access request to the out-of-chain data sources sent by the first smart contract on the consortium block chain.

In another embodiment of the present disclosure, the searching module 420 in FIG. 4 sends a query request to the out-of-chain data sources according to the access request, and receives out-of-chain data returned by the out-of-chain data sources.

In another embodiment of the present disclosure, the sending module 430 in FIG. 4 initiates a transaction to the second smart contract according to an address of the second smart contract, and sends the out-of-chain data.

In another embodiment of the present disclosure, the agent program runs on a server with the consortium block chain or runs on a server without the consortium block chain.

In another embodiment of the present disclosure, the out-of-chain data includes at least one of meteorological data or weather data, stock market transaction data, foreign exchange data and traffic data.

In another embodiment of the present disclosure, the agent program stores the address of the second smart contract.

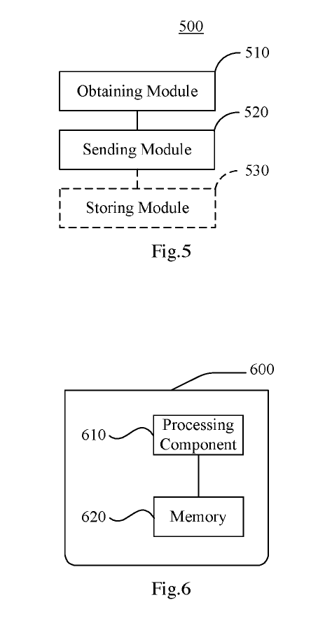

FIG. 5 is a block diagram of a system 500 for accessing out-of-chain data based on a consortium block chain according to an exemplary embodiment of the present disclosure. The system 500 for accessing out-of-chain data based on a consortium block chain in FIG. 5 runs a second smart contract to realize the access of out-of-chain data. As shown in FIG. 5, the system 500 for accessing out-of-chain data includes a receiving module 510 and a sending module 520.

The receiving module 510 is configured to receive an access request to out-of-chain data sources sent by a first smart contract on the consortium block chain, receive a query request sent by an agent program, wherein the query request is used to request a query whether the access request exists, and receive out-of-chain data in the out-of-chain data sources returned by the agent program.

The sending module 520 is configured to send the out-of-chain data to the first smart contract.

According to the technical solutions provided by the embodiments of the present disclosure, by receiving an access request to out-of-chain data sources sent by a first smart contract on a consortium block chain; receiving a query request sent by an agent program, wherein the query request is used to request a query whether the access request exists; receiving out-of-chain data in the out-of-chain data sources returned by the agent program; and sending the out-of-chain data to the first smart contract, an access function of the out-of-chain data may be quickly introduced on a prior block chain platform without modifying an underlying engine of the smart contract to realize the access to a plurality of out-of-chain data sources, and thus the implementation is simplified and the implementation cycle is shortened.

In another embodiment of the present disclosure, an address of the second smart contract is published on the consortium block chain, and the access request includes a query request, and the system for accessing out-of-chain data further includes: a storing module 530 configured to store the query request and an address of the first smart contract, wherein the receiving module 510 receives the query request sent by invoking an address of the second smart contract and a query method of the second smart contract when the first smart contract needs to access to the out-of-chain data sources, and the sending module 520 sends a notification to the first smart contract according to the address of the first smart contract, and sends the out-of-chain data.

In another embodiment of the present disclosure, the agent program runs on a server with the consortium block chain or runs on a server without the consortium block chain.

In another embodiment of the present disclosure, the out-of-chain data includes at least one of meteorological data or weather data, stock market transaction data, foreign exchange data and traffic data.

With respect to the apparatuses in the above embodiments, the specific manners for performing operations for individual modules therein have been described in detail in the embodiments regarding the methods, which will not be elaborated herein.

FIG. 6 is a block diagram of a system 600 for accessing out-of-chain data based on a consortium block chain according to an exemplary embodiment of the present disclosure.

Referring to FIG. 6, the system 600 includes a processing component 610 that further includes one or more processors, and memory resources represented by a memory 620 for storing instructions executable by the processing component 610, such as application programs. The application programs stored in the memory 620 may include one or more modules each corresponding to a set of instructions. Further, the processing component 610 is configured to execute the instructions to perform the above method for accessing out-of-chain data based on a consortium block chain.

The system 600 may also include a power supply module configured to perform power management of the system 600, wired or wireless network interface(s) configured to connect the system 600 to a network, and an input/output (I/O) interface. The system 600 may operate based on an operating system stored in the memory 620, such as Windows Server™, Mac OS X™, Unix™, Linux™, FreeBSD™, or the like.

A non-temporary computer readable storage medium, when instructions in the storage medium are executed by a processor of the above system 600, the instructions cause the above system 600 to perform a method for accessing out-of-chain data based on a consortium block chain, wherein the method for accessing out-of-chain data is performed by an agent program, and the method for accessing out-of-chain data includes: obtaining an access request to out-of-chain data sources sent by a first smart contract on the consortium block chain from a second smart contract, wherein the second smart contract is generated based on the out-of-chain data sources and is deployed on the consortium block chain; searching out-of-chain data in the out-of-chain data sources according to the access request; and sending the out-of-chain data to the second smart contract.

Persons skilled in the art may realize that, units and algorithm steps of examples described in combination with the embodiments disclosed here can be implemented by electronic hardware, computer software, or the combination of the two. Whether the functions are executed by hardware or software depends on particular applications and design constraint conditions of the technical solutions. Persons skilled in the art may use different methods to implement the described functions for each particular application, but it should not be considered that the implementation goes beyond the scope of the present disclosure.

It can be clearly understood by persons skilled in the art that, for the purpose of convenient and brief description, for a detailed working process of the foregoing system, device and unit, reference may be made to the corresponding process in the method embodiments, and the details are not to be described here again.

In several embodiments provided in the present application, it should be understood that the disclosed system, device, and method may be implemented in other ways. For example, the described device embodiments are merely exemplary. For example, the unit division is merely logical functional division and may be other division in actual implementation. For example, multiple units or components may be combined or integrated into another system, or some features may be ignored or not performed. Furthermore, the shown or discussed coupling or direct coupling or communication connection may be accomplished through indirect coupling or communication connection between some interfaces, devices or units, or may be electrical, mechanical, or in other forms.

Units described as separate components may be or may not be physically separated. Components shown as units may be or may not be physical units, that is, may be integrated or may be distributed to a plurality of network units. Some or all of the units may be selected to achieve the objective of the solution of the embodiment according to actual demands.

In addition, the functional units in the embodiments of the present disclosure may either be integrated in a processing module, or each be a separate physical unit; alternatively, two or more of the units are integrated in one unit.

If implemented in the form of software functional units and sold or used as an independent product, the integrated units may also be stored in a computer readable storage medium. Based on such understanding, the technical solution of the present disclosure or the part that makes contributions to the prior art, or a part of the technical solution may be substantially embodied in the form of a software product. The computer software product is stored in a storage medium, and contains several instructions to instruct computer equipment (such as, a personal computer, a server, or network equipment) to perform all or a part of steps of the method described in the embodiments of the present disclosure. The storage medium includes various media capable of storing program codes, such as, a USB flash drive, a mobile hard disk, a Read-Only Memory (Read-Only Memory, ROM), a Random Access Memory (Random Access Memory, RAM), a magnetic disk, an optical disk or the like.

In addition, it should be noted that the combination of various technical features in the present disclosure is not limited to the combination manner described in the claims of the present disclosure or the combination manner described in the specific embodiments, and all technical features described in the present disclosure may be freely combined or integrated in any manner unless there is a contradiction between them.

It should to be noted that the above descriptions are only specific embodiments of the present disclosure, and it is obvious that the present disclosure is not limited to the above embodiments, and there are many similar variations. All modifications that are directly derived or associated by those skilled in the art should be within the scope of the present disclosure.

The above are only the preferred embodiments of the present disclosure and are not configured to limit the scope of the present disclosure. Any modifications, equivalent substitutions, improvements and so on made within the spirit and principle of the present disclosure should be included within the scope of the present disclosure.

What is claimed is:

1. A method for accessing out-of-chain data based on a consortium block chain, wherein the method for accessing out-of-chain data is performed by an agent program, the method for accessing out-of-chain data comprising:
obtaining an access request to out-of-chain data sources sent by a first smart contract on the consortium block chain from a second smart contract, wherein the second smart contract is generated based on the out-of-chain data sources and is deployed on the consortium block chain;
searching out-of-chain data in the out-of-chain data sources according to the access request; and
sending the out-of-chain data to the second smart contract.

2. The method for accessing out-of-chain data according to claim 1, wherein the obtaining an access request to out-of-chain data sources sent by a first smart contract on the consortium block chain from a second smart contract comprises:
querying the second smart contract actively to obtain the access request to the out-of-chain data sources sent by the first smart contract on the consortium block chain.

3. The method for accessing out-of-chain data according to claim 1, wherein the searching out-of-chain data in the out-of-chain data sources according to the access request comprises:
sending a query request to the out-of-chain data sources according to the access request; and
receiving out-of-chain data returned by the out-of-chain data sources.

4. The method for accessing out-of-chain data according to claim 1, wherein the sending the out-of-chain data to the second smart contract comprises:
initiating a transaction to the second smart contract according to an address of the second smart contract, and sending the out-of-chain data.

5. The method for accessing out-of-chain data according to claim 1, wherein the agent program runs on a server with the consortium block chain or runs on a server without the consortium block chain.

6. The method for accessing out-of-chain data according to claim 1, wherein the out-of-chain data comprises at least one of meteorological data or weather data, stock market transaction data, foreign exchange data and traffic data.

7. The method for accessing out-of-chain data according to claim 1, wherein the agent program stores an address of the second smart contract.

8. A method for accessing out-of-chain data based on a consortium block chain, wherein the method for accessing out-of-chain data is performed by a second smart contract, and the second smart contract is generated based on out-of-chain data sources and is deployed on the consortium block chain, the method for accessing out-of-chain data comprising:
receiving an access request to the out-of-chain data sources sent by a first smart contract on the consortium block chain;
receiving a query request sent by an agent program, wherein the query request is used to request a query whether the access request exists;
receiving out-of-chain data in the out-of-chain data sources returned by the agent program; and
sending the out-of-chain data to the first smart contract.

9. The method for accessing out-of-chain data according to claim 8, wherein an address of the second smart contract is published on the consortium block chain, and the access request comprises a query request, and after the receiving an access request to the out-of-chain data sources sent by a first smart contract on the consortium block chain, the method for accessing out-of-chain data further comprising:
storing the query request and an address of the first smart contract,
wherein the receiving an access request to the out-of-chain data sources sent by a first smart contract on the consortium block chain comprises:
receiving the query request sent by invoking an address of the second smart contract and a query method of the second smart contract when the first smart contract needs to access to the out-of-chain data sources,
wherein the sending the out-of-chain data to the first smart contract comprises:
sending a notification to the first smart contract according to the address of the first smart contract, and sending the out-of-chain data.

10. The method for accessing out-of-chain data according to claim 8, wherein the agent program runs on a server with the consortium block chain or runs on a server without the consortium block chain.

11. The method for accessing out-of-chain data according to claim 8, wherein the out-of-chain data comprises at least one of meteorological data or weather data, stock market transaction data, foreign exchange data and traffic data.

12. A system for accessing out-of-chain data based on a consortium block chain, wherein the system for accessing out-of-chain data runs an agent program to realize an access of the out-of-chain data, the system for accessing out-of-chain data comprising:
a processor; and
a memory for storing instructions executable by the processor;
wherein the processor is configured to:
obtain an access request to out-of-chain data sources sent by a first smart contract on the consortium block chain from a second smart contract, wherein the second smart contract is generated based on the out-of-chain data sources and is deployed on the consortium block chain;
search out-of-chain data in the out-of-chain data sources according to the access request; and
send the out-of-chain data to the second smart contract.

13. The system for accessing out-of-chain data according to claim 12, wherein the processor is configured to:
query the second smart contract actively to obtain the access request to the out-of-chain data sources sent by the first smart contract on the consortium block chain.

14. The system for accessing out-of-chain data according to claim 12, wherein the processor is configured to:
send a query request to the out-of-chain data sources according to the access request, and
receive out-of-chain data returned by the out-of-chain data sources.

15. The system for accessing out-of-chain data according to claim 12, wherein the processor is configured to:
initiate a transaction to the second smart contract according to an address of the second smart contract, and send the out-of-chain data.

16. The system for accessing out-of-chain data according to claim 12, wherein the agent program runs on a server with the consortium block chain or runs on a server without the consortium block chain.

17. A system for accessing out-of-chain data based on a consortium block chain, wherein the system for accessing out-of-chain data runs a second smart contract to realize an access of the out-of-chain data, and the second smart contract is generated based on out-of-chain data sources and is deployed on the consortium block chain, the system for accessing out-of-chain data comprising:
a processor; and
a memory for storing instructions executable by the processor;
wherein the processor is configured to:
receive an access request to the out-of-chain data sources sent by a first smart contract on the consortium block chain, receive a query request sent by an agent program, and receive out-of-chain data in the out-of-chain data sources returned by the agent program, wherein the query request is used to request a query whether the access request exists; and
send the out-of-chain data to the first smart contract.

18. The system for accessing out-of-chain data according to claim 17, wherein an address of the second smart contract is published on the consortium block chain, and the access request comprises a query request, and the processor is configured to:
store the query request and an address of the first smart contract,
wherein the processor is further configured to receive the query request sent by invoking an address of the second smart contract and a query method of the second smart contract when the first smart contract needs to access to the out-of-chain data sources, and send a notification to the first smart contract according to the address of the first smart contract, and send the out-of-chain data.
